(19) United States
(12) Patent Application Publication
(10) Pub. No.: US 2026/0249670 A1
(43) Pub. Date: Aug. 27, 2026

(54) MOUNTING STRUCTURE OF SEAMING WELT MEMBER, SENSOR, AND WEATHER STRIP

(71) Applicant: Nishikawa Rubber Co., Ltd., Hiroshima (JP)

(72) Inventor: Michihiko MATSUMOTO, Hiroshima (JP)

(73) Assignee: Nishikawa Rubber Co., Ltd., Hiroshima (JP)

(21) Appl. No.: 19/418,082

(22) Filed: Dec. 12, 2025

(30) Foreign Application Priority Data
Feb. 21, 2025 (JP) 2025-026879

(51) Int. Cl. B60J 10/86; B60J 10/27; B60J 10/30

(52) U.S. Cl. CPC B60J 10/86; B60J 10/27; B60J 10/30

(57) ABSTRACT

To sufficiently ensure a holding force of a seaming welt member after being mounted while reducing a force required in mounting the seaming welt member to a flange and thus increasing workability during mounting.

A seaming welt member 1 includes a first side wall portion 10, a second side wall portion 20, a connecting wall portion 30, and a first holding lip 51 and a second holding lip 52 that are provided on an inner surface of the first side wall portion 10. The first holding lip 51 is connected to the first side wall portion 10 via a thin wall portion 53. The second holding lip 52 is configured to have a bent shape located separated from a root portion 51a of the first holding lip 51 to a near side in an insertion direction of a flange 104 when the flange 104 is not inserted and, on the other hand, during insertion of the flange 104, be deformed into an elongated shape due to a pressing force by the flange 104, and is configured such that a tip end portion thereof engages between the root portion 51a of the first holding lip 51 and the inner surface of the first side wall portion 10.

### CROSS-REFERENCE TO RELATED APPLICATION

This application claims priority to Japanese Patent Application No. 2025-026879 filed on Feb. 21, 2025, the entire disclosure of which is incorporated by reference herein.

### TECHNICAL FIELD

The present disclosure relates to a mounting structure of a seaming welt member, a sensor, and a weather strip.

### BACKGROUND

A hemming portion obtained by stacking multiple panels each being formed by press-molding a metal plate material and hemming ends of the panels is provided, for example, around a peripheral edge of an automobile door or around a peripheral edge of a door opening portion and a seaming welt member having an approximately U-shaped cross section and that covers the hemming portion is mounted thereon to prevent exposure of the hemming section. As the seaming welt member of this type, for example, a sensor-equipped member provided with a foreign object detection sensor that is mounted on a flange of a sliding door, an opening seal member, a trunk seal member, and a parting seal member, and the like have been known, and the seaming welt member configured of any one of these members is mounted on a flange.

Japanese Unexamined Patent Publication No. S54-163950 discloses a mounting structure used for mounting a seaming welt member formed of rubber or plastic on a flange. The seaming welt member of Japanese Unexamined Patent Publication No. S54-163950 has an approximately U-shaped cross section with one top portion and a pair of side legs. A holding tongue portion is provided on an inner side of each of the side legs. The holding tongue portion is formed of a web integrally formed with the side legs and a thick-walled head portion connected to the web.

### SUMMARY OF THE INVENTION

### Technical Problem

In mounting the seaming welt member of Japanese Unexamined Patent Publication No. S54-163950 on the flange, the flange is inserted between the pair of holding tongue portions, and at this time, insertion of the flange is allowed by pivoting of the head portion about a side connected to the web as a fulcrum.

On the other hand, when an external force acts on the seaming welt member with the flange inserted therein in a direction in which the seaming welt member is separated from the flange, a base surface of the head portion abuts on a limiting surface that functions as a stopper, so that the head portion is prevented from pivoting in a flange disengagement direction and a holding force of the seaming welt member on the flange is increased by tensioning the head portion.

Incidentally, in mounting the seaming welt member of Japanese Unexamined Patent Publication No. S54-163950 on the flange, there is a demand for minimizing a force required for mounting to increase workability during mounting. On the other hand, there is a demand for increasing, in a state where the seaming welt is mounted on the flange, the holding force of the seaming welt member onto the flange such that the seaming welt member is not easily detached from the flange. Thus, the seaming welt member that is mounted on the flange is required to satisfy these conflicting demands at a high level.

In this regard, the seaming welt member of Japanese Unexamined Patent Publication No. S54-163950 is configured such that the head portion pivots via the web during insertion of the flange, but in order to reduce a force required for insertion, the web needs to be made thinner. However, when the web is thinned, there is a probability that, when an external force in the direction in which the seaming welt member is separated from the flange acts on the flange, attitude control of the head portion is insufficient, and as a result, the holding force of the seaming welt member is reduced.

In view of the foregoing, the present disclosure has been devised, and therefore, it is an object of the present disclosure to, while reducing a force required in mounting the seaming welt member on the flange to increase workability during mounting, sufficiently ensure the holding force of the seaming welt member after being mounted.

### Solution to the Problem

In order to achieve the object described above, in a first aspect of the present disclosure, a mounting structure of a seaming welt member used for mounting the seaming welt member on a flange of an automobile can be assumed. The seaming welt member includes a first side wall portion disposed on one side in a thickness direction of the flange, a second side wall portion disposed on the other side in the thickness direction of the flange, a connecting wall portion that extends in the thickness direction of the flange and connects the first side wall portion and the second side wall portion, and a first holding lip and a second holding lip that are provided on an inner surface of the first side wall portion. The first holding lip is configured such that a root portion thereof is connected to the inner side of the first side wall portion via a thin wall portion and is in an inclined attitude in which the first holding lip gets closer to the second side wall portion as proceeding to a deep side in an insertion direction of the flange. The second holding lip is positioned further on a near side in the insertion direction of the flange than the first holding lip, is configured to have a bent shape located separated from the root portion of the first holding lip to the near side in the insertion direction of the flange when the flange is not inserted and, on the other hand, during insertion of the flange, be deformed from the bent shape into an elongated shape due to a pressing force by the flange, and is configured such that, when insertion of the flange is completed, a tip end portion thereof engages between the root portion of the first holding lip and the inner surface of the first side wall portion.

According to the above-described configuration, in mounting the seaming welt member to the flange, the flange is inserted between the first side wall portion and the second side wall portion of the seaming welt member. At this time, when the flange contacts the second holding lip, the second holding lip in the bent shape is deformed to be in an elongated shape, so that an insertion force of the flange is reduced. Moreover, the flange inserted between the first side wall portion and the second side wall portion also contacts the first holding lip but, since the first holding lip is configured such that the root portion thereof is connected to the inner surface of the first side wall portion via the thin wall portion, the first holding lip is easily displaced with a small force, so that the insertion force is reduced.

When the flange is completely inserted, the second holding lip is deformed in an elongated shape, so that the tip end portion of the second holding lip engages between the root portion of the first holding lip and the inner surface of the first side wall portion. Thus, the first holding lip does not rotate in an opposite direction to the insertion direction of the flange, and therefore, in a case where an external force in a direction in which the seaming welt member is separated from the flange acts on the seaming welt member with the flange inserted therein, the first holding lip is tensioned between the flange and the first side wall portion. With the first holding lip tensioned therebetween, a retention force of the seaming welt member is increased.

In a second aspect of the present disclosure, a recessed portion that is opened to the near side in the insertion direction of the flange may be formed between the root portion of the first holding lip and the inner surface of the first side wall portion. In this case, the tip end portion of the second holding lip can be caused to engage in the recessed portion when the insertion of the flange is completed.

Thus, the tip end portion of the first holding lip can be reliably caused to engage between the root portion of the first holding lip and the inner surface of the first side wall portion.

In a third aspect of the present disclosure, the second holding lip may include an inclined plate portion that is inclined to be positioned further on the deep side in the insertion direction of the flange as proceeding from the inner surface of the first side wall portion to the tip end side and a tip end plate portion that extends from a tip end portion of the inclined plate portion to the deep side in the insertion direction of the flange. In this case, the inclined plate portion and the tip end plate portion together can form the bent shape.

In a fourth aspect of the present disclosure, the flange may include a sealer applied on the one side in the thickness direction. In this case, the second holding lip can be pressed by the sealer during insertion of the flange.

In a fifth aspect of the present disclosure, the sealer may be applied to a portion of the flange separated from the tip end portion of the flange in the insertion direction toward a base end thereof. In this case, the tip end portion of the first holding lip can be caused to abut on a portion of the flange located further on the tip end side in the insertion direction than the sealer when insertion is completed. Thus, the tip end portion of the first holding lip can be reliably caused to abut on the flange and be tensioned.

In a sixth aspect of the present disclosure, a portion between a root portion and the tip end portion of the second holding lip may be formed to be separated from the inner surface of the first side wall portion when insertion of the flange is completed. That is, since the sealer is amorphous when attaching to a panel, a thickness of the sealer in a state where the sealer is applied to the flange is less likely to be set to a constant thickness. According to the sixth aspect, even when the thickness of the sealer changes to some extent, change in the thickness of the sealer can be followed by deformation of the second holding lip, so that a force required in mounting the seaming welt member to the flange can be reduced.

### Advantages of the Invention

As described above, while a force required in mounting a seaming welt member to a flange can be reduced to increase workability during mounting, a holding force of the seaming welt member after being mounted can be sufficiently ensured.

### BRIEF DESCRIPTION OF THE DRAWINGS

FIG. 1 is a left side view of an automobile to which a mounting structure of a seaming welt member according to an embodiment of the present disclosure is applied.

FIG. 2 is a perspective view illustrating a front portion of a left sliding door with the seaming welts mounted thereon.

FIG. 3 is a cross-sectional view corresponding to the line III-III in FIG. 2, illustrating a state of a flange with the seaming welt member omitted.

FIG. 4 is a cross-sectional view corresponding to the line III-III in FIG. 2, illustrating a state before insertion into the flange (functional components, such as a sealing function, a sensor function, or the like, are omitted).

FIG. 5 is a cross-sectional view corresponding to the line III-III in FIG. 2, illustrating a stage where insertion of the seaming welt member of FIG. 4 into the flange has just started.

FIG. 6 is a cross-sectional view corresponding to the line III-III in FIG. 2, illustrating a stage where the seaming welt member of FIG. 4 has been partially inserted into the flange.

FIG. 7 is a cross-sectional view corresponding to the line III-III in FIG. 2, illustrating a state where the seaming welt member of FIG. 4 is completely inserted into the flange.

### DETAILED DESCRIPTION

An embodiment of the present disclosure will be described below with reference to the accompanying drawings. Note that the following preferred embodiment is a mere example by nature, and is not intended to limit the scope of applications or uses of the present disclosure. For example, a relative size of each member and a positional relationship between members illustrated in the drawings are used for describing one embodiment and do not limit the present disclosure.

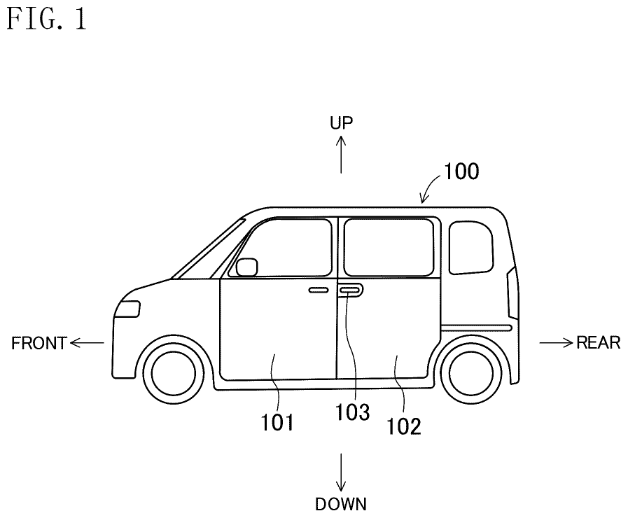

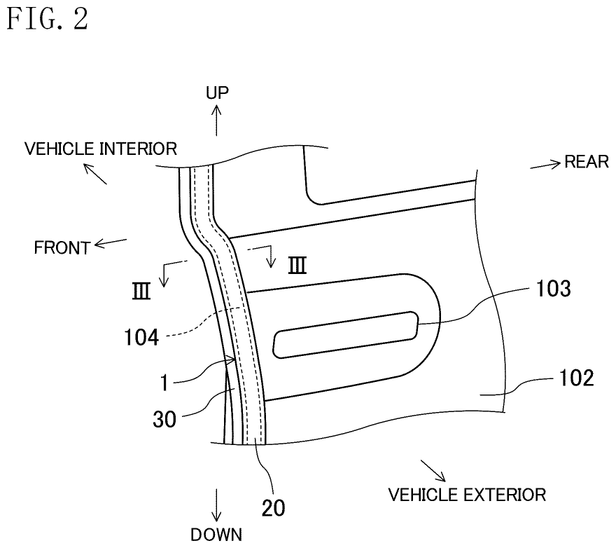

FIG. 1 is a left side view of an automobile 100 to which a mounting structure of a seaming welt member according to an embodiment of the present disclosure is applied. A front door 101 formed of a hinged door is provided at a front side on each of both left and right sides of the automobile 100. A sliding door 102 is provided at a rear side of the front door 101 on each of both the left and right sides of the automobile 100. FIG. 2 is a perspective view illustrating a front portion of the sliding door 102 at the left side. In each drawing, a front side of a vehicle is simply referred to as “front,” and a rear side of the vehicle is simply referred to as “rear.” A vehicle-interior side and a vehicle-exterior side are defined as illustrated in FIG. 2. A vehicle interior-exterior direction is the same as a left-right direction (vehicle width direction) of the automobile 100.

A door handle 103 used for operating the sliding door 102 is provided on the front portion of the sliding door 102. A flange 104 extending in an up-down direction is provided at a front end portion of the sliding door 102. The flange 104 of the sliding door 102 is an example of a flange of the automobile 100.

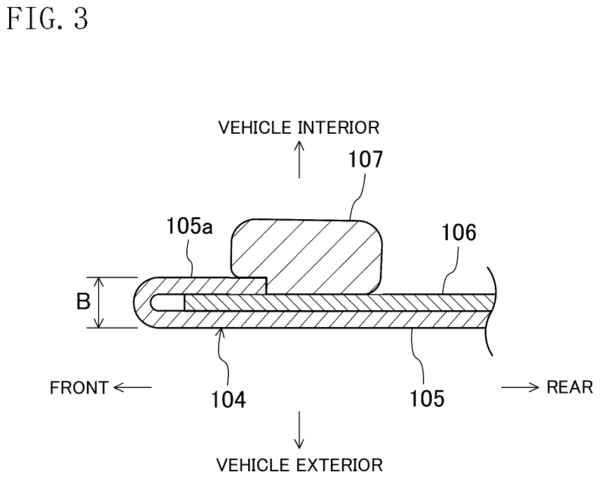

A seaming welt member 1 is mounted on the flange 104 of the sliding door 102. FIG. 3 is a cross-sectional view of the flange 104 corresponding to the line III-III in FIG. 2, illustrating a state where the seaming welt member 1 is omitted. As illustrated in FIG. 3, the sliding door 102 includes an outer panel 105 forming a vehicle-exterior side of the sliding door 102 and an inner panel 106 forming a vehicle-interior side of the sliding door 102. Each of the outer panel 105 and the inner panel 106 is formed by press forming a metal sheet.

A hemming portion 105a formed by hemming is provided at a front portion of the outer panel 105. That is, a front portion of the inner panel 106 abuts on a surface of the outer panel 105 at the vehicle-interior side. The hemming portion 105a of the outer panel 105 is folded rearward by hemming and grips the front portion of the inner panel 106 in a thickness direction. With the hemming portion 105a provided, the outer panel 105 and the inner panel 106 can be joined to be integrated.

The thickness direction of the flange 104 matches the vehicle interior-exterior direction. In this embodiment, one side in the thickness direction of the flange 104 is defined as the vehicle-interior side and the other side in the thickness direction of the flange 104 is defined as the vehicle-exterior side.

The flange 104 includes a sealer 107 applied on the vehicle-interior side. The sealer 107 is applied to a portion that is separated from a tip end portion (front end portion) of the flange 104 in an insertion direction in which the flange 104 is inserted into the seaming welt member 1 to a base end side thereof (rearward). Specifically, an application position of the sealer 107 is a position where the sealer 107 covers an end of the hemming portion 105a of the outer panel 105 and applying the sealer 107 at this position provides a rust preventing effect.

The sealer 107 is amorphous. For example, when the paste-like sealer 107 is applied to the portion of the flange portion 104 at the vehicle-interior side, the sealer 107 is hardened over time. FIG. 3 illustrates the sealer 107 in a hardened state. Since an amorphous material is applied, a shape and a thickness of the hardened sealer 107 varies from portion to portion in some cases.

A mounting structure of the seaming welt member 1 according to this embodiment is a structure used for mounting the seaming welt member 1 to the flange 104 of the sliding door 102. In this case, although not essential to the present invention, a pinch detection sensor (not illustrated) can be provided on the seaming welt member 1. The pinch detection sensor is a sensor that detects a foreign object existing between the front end portion of the sliding door 102 and a vehicle body and is configured to cause current change when a foreign object contacts the pinch detection sensor. The pinch detection sensor may be formed separately from the seaming welt member 1 and assembled as an integrated component, and may be integrally formed with the seaming welt member 1, for example, during extrusion molding. In this case, the pinch detection sensor may be a sensor to which the mounting structure of the seaming welt member 1 is applied.

Although not essential to the present invention, a weather strip function may be added to the seaming welt member 1. In this case, a weather strip to which the mounting structure of the seaming welt member 1 is applied can be used. With a sealing portion (not illustrated), for example, a portion with a hollow-shaped cross section or a portion with a tongue-shaped cross section, that abuts on the vehicle body or another door when the sliding door 102 is closed to prevent intrusion of water, sound, wind, or the like into a vehicle interior provided on the seaming welt member 1, the weather strip function can be added to the seaming welt member 1. This can be achieved by configuring a composite seaming welt member 1 including the sensor and the weather strip function assembled therewith.

Moreover, the seaming welt member 1 not only may be disposed linearly but also may be an opening seal that is provided so as to be arranged along an opening formed in the automobile 100 with a flange curved along an extension line, may be a bonnet seal, may be a trunk seal arranged at a peripheral edge portion of a trunk lid or a trunk opening, and may be a boundary seal disposed at a boundary portion. As described above, an arrangement position and a shape of the seaming welt member 1 are not particularly limited, and the mounting structure of the seaming welt member 1 according to the present disclosure can be applied in mounting the seaming welt member 1 on various types of flanges of the automobile 100.

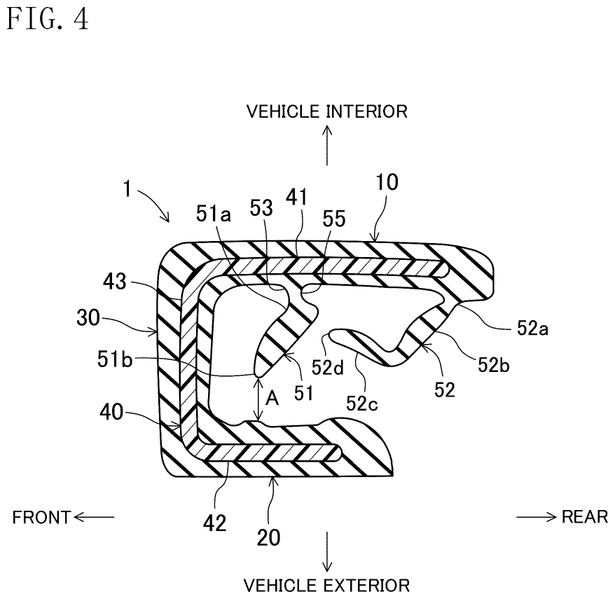

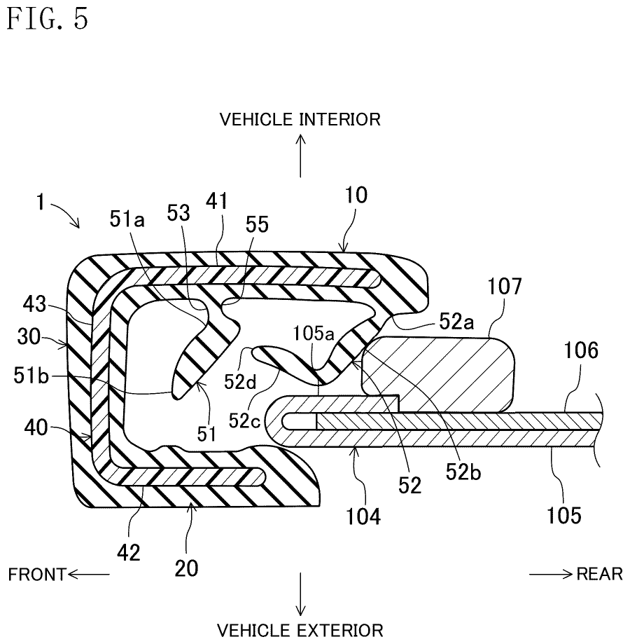

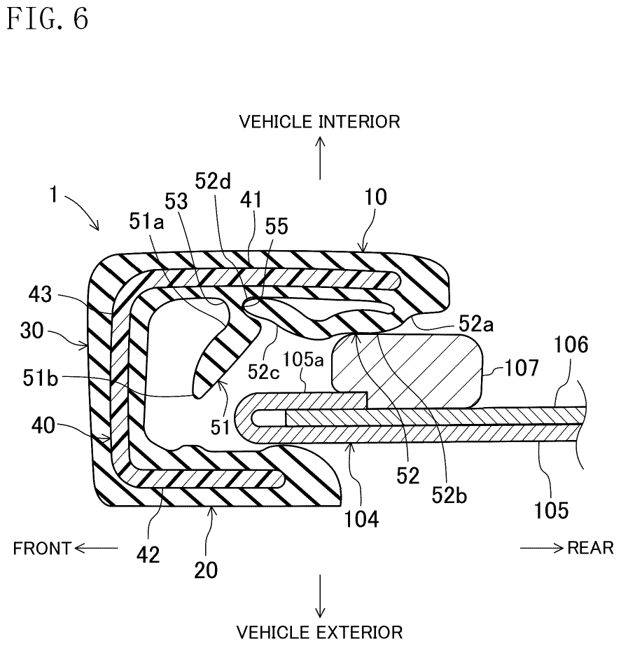

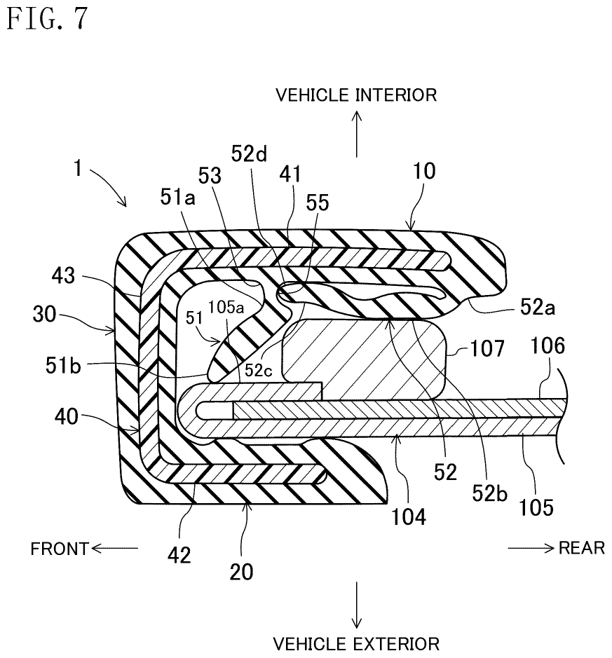

FIG. 4 is a cross-sectional view of the seaming welt member 1 corresponding to the line III-III in FIG. 2, illustrating a state before insertion into the flange 104. FIG. 5 to FIG. 7 are cross-sectional views corresponding to the line III-III in FIG. 2. FIG. 5 illustrates a stage where insertion of the flange 104 into the seaming welt member 1 has just started, FIG. 6 illustrates a stage where flange 104 is partially inserted into the seaming welt member 1, and furthermore, FIG. 7 illustrates a state where the flange 104 is completely inserted into the seaming welt member 1.

The seaming welt member 1 includes a vehicle-interior side wall portion (first side wall portion) 10, a vehicle-exterior side wall portion (second side wall portion) 20, a connecting wall portion 30, and a core material 40. The vehicle-interior side wall portion 10 is a wall portion disposed at the vehicle-interior side that is one side in the thickness direction of the flange 104 and extends along the flange 104 in the up-down direction and the front-rear direction. The vehicle-exterior side wall portion 20 is a wall portion disposed at the vehicle-exterior side that is the other side in the thickness direction of the flange 104 and extends along the flange 104 in the up-down direction and the front-rear direction.

The connecting wall portion 30 is a wall portion that extends in the thickness direction of the flange 104 and also in the up-down direction and connects the vehicle-interior side wall portion 10 and the vehicle-exterior side wall portion 20. A portion of the connecting wall section 30 located at the vehicle-interior side is integrated with a front end portion of the vehicle-interior side wall portion 10 that is a base end portion thereof, while a portion of the connecting wall portion 30 located at the vehicle-exterior side is integrated with a front end portion of the vehicle-exterior side wall portion 20 that is a base end portion of thereof. Therefore, the connecting wall section 30 extends from the front end portion of the vehicle-interior side wall portion 10 to the front end portion of the vehicle-exterior side wall portion 20.

A dimension of the vehicle-interior side wall portion 10 in the front-rear direction is set longer than a dimension of the vehicle-exterior side wall portion 20 in the front-rear direction. Thus, a rear end portion of the vehicle-interior side wall portion 10 is positioned further on a rear side than a rear end portion of the vehicle-exterior side wall portion 20.

The core material 40 is embedded in the vehicle-interior side wall portion 10, the vehicle-exterior side wall portion 20, and the connecting wall portion 30. Portions of the seaming welt member 1 other than the core material 40 are formed of an elastic material, such as, for example, ethylene propylene diene rubber (EPDM), thermoplastic elastomer, or the like. A material of the core member 40 may be any material that is harder and less deformable than the elastic material forming the portions of the seaming welt member 1 other than the core member 40 and examples of the material of the core material 40 can include, for example, a hard resin material, a metal material, or the like. The core member 40 may be provided as necessary and is not an essential component of the present invention.

The core member 40 includes a vehicle-interior side plate portion 41 that is embedded in the vehicle-interior side wall portion 10, a vehicle-exterior side plate portion 42 that is embedded in the vehicle-exterior side wall portion 20, and a connecting plate portion 43 that is embedded in the connecting wall portion 30. The vehicle-interior side plate portion 41, the vehicle-exterior side plate portion 42, and the connecting plate portion 43 are integrally molded. A dimension of the vehicle-interior side panel portion 41 in the front-rear direction is set longer than a dimension of the vehicle-exterior side panel portion 42 in the front-rear direction so as to correspond to a dimensional difference between the vehicle-interior side wall portion 10 and the vehicle-exterior side wall portion 20 in the front-rear direction. Since the core material 40 is embedded, deformation of the seaming welt member 1 in an opening direction, that is, deformation where a rear end portion of the vehicle-interior side wall portion 10 and a rear end portion of the vehicle-exterior side wall portion 20 are separated apart from each other is suppressed.

A first holding lip 51 and a second holding lip 52 are provided on an inner surface of the vehicle-interior side wall portion 10. A root portion 51a of the first holding lip 51 is connected to the inner surface of the vehicle-interior side wall portion 10 via a thin wall portion 53 and the first holding lip 51 is integrally molded with the vehicle-interior side wall portion 10. A thickness of the first holding lip 51 is smaller than a thickness of the vehicle-interior side wall portion 10.

A recessed portion 55 that is opened rearward is formed between the root portion 51a of the first holding lip 51 and the inner surface of the vehicle-interior side wall portion 10. The first holding lip 51 is in an inclined attitude in which the first holding lip 51 gets closer to the vehicle-exterior side wall portion 20 as proceeding to a deep side in the insertion direction of the flange 104 (forward in this embodiment).

As illustrated in FIG. 4, in a stage before insertion of the flange 104, a tip end portion 51b of the first holding lip 51 is separated from the inner surface of the vehicle-exterior side wall portion 20 by a distance A. The distance A is set shorter than a thickness dimension B of a portion of the flange 104 that is positioned further on the front side than the sealer 107, as illustrated in FIG. 3.

The second holding lip 52 is positioned further on a near side in the insertion direction of the flange 104 (the rear side in this embodiment) than the first holding lip 51 and is integrally formed with the vehicle-interior side wall portion 10. A thickness of the second holding lip 52 is smaller than the thickness of the vehicle-interior side wall portion 10. A root portion 52a of the second holding lip 52 is separated rearward from the root portion 51a of the first holding lip 51 and is positioned near the rear end portion of the vehicle-exterior side wall portion 20.

As illustrated in FIG. 4, the second holding lip 52 is configured to have a bent shape located separated rearward from the root portion 51a of the first holding lip 51 when the flange 104 is not inserted. Specifically, the second holding lip 52 includes an inclined plate portion 52b that is inclined to be positioned further on the front side and the vehicle-exterior side as proceeding from the inner surface of the vehicle-interior side wall portion 10 toward a tip end of the second holding lip 52 and a tip end plate portion 52c that extends forward from the tip end portion of the inclined plate portion 52b. The inclined plate portion 52b and the tip end plate portion 52c together form the bent shape of the flange 104 when the flange 104 is not inserted.

When the flange 104 is not inserted, a boundary portion between the inclined plate portion 52b and the tip end plate portion 52c in the second holding lip 52 is closest to the inner surface of the vehicle-exterior side wall portion 20. The tip end plate portion 52c is formed to be separated more from the inner surface of the vehicle-exterior side wall portion 20 as proceeding forward from the boundary portion described above. That is, when the flange 104 is not inserted, a tip end portion 52d of the tip end plate portion 52c is positioned so as to face the inner surface of the vehicle-interior side wall portion 10. Moreover, when the flange 104 is not inserted, the tip end portion 52d of the tip end plate portion 52c is positioned further on the rear side than the root portion 51a of the first holding lip 51.

A state illustrated in FIG. 5 is a state immediately after the flange 104 contacts the second holding lip 52, and therefore, the second holding lip 52 has substantially the same shape as that illustrated in FIG. 4. On the other hand, as illustrated in FIG. 6 and FIG. 7, when the flange 104 is inserted between the vehicle-interior side wall portion 10 and the vehicle-exterior side wall portion 20, the flange 104 contacts the second holding lip 52 from the vehicle-exterior side and presses the second holding lip 52 toward the vehicle-interior side. Since the sealer 107 is provided on a portion of the flange 104 on the vehicle-interior side, the second holding lip 52 is pressed by the sealer 107, not by a plate metal portion of the flange 104, during insertion of the flange 104.

Upon receiving a pressing force toward the vehicle-interior side by the flange 104 during insertion of the flange 104, the second holding lip 52 is deformed from the bent shape illustrated in FIG. 4 and FIG. 5 into an elongated shape illustrated in FIG. 6 and FIG. 7 due to the pressing force. As illustrated in FIG. 7, when insertion of the flange 104 is completed, the tip end portion 52d of the second holding lip 52 engages in the recessed portion 55 between the root portion 51a of the first holding lip 51 and the inner surface of the vehicle-interior side wall portion 10.

When insertion of the flange 104 is completed, a portion between the root portion 52a and the tip end portion 52d of the second holding lip 52 is formed to be separated from the inner surface of the vehicle-interior side wall portion 10. Specifically, the boundary portion between the inclined plate section 52b and the tip plate section 52c in the second holding lip 52 is in a shape bent in a direction in which the boundary portion is separated from the inner surface of the vehicle-interior side wall portion 10.

Moreover, when insertion of the flange 104 is completed, the tip end portion 51b of the first holding lip 51 abuts on a portion (plate metal portion) of the flange 104 located further on the front side than the sealer 107. In a state where the tip end portion 51b of the first holding lip 51 abuts on the flange 104, the first holding lip 51 is inclined so as to be closer to the vehicle-exterior side wall portion 20 as proceeding forward. Generally, the plate metal portion of the flange 104 is a portion that has higher shape accuracy than that of the sealer 107 and the tip end portion 51b of the first holding lip 51 can be caused to abut on the portion having a higher shape accuracy.

### Mounting of Seaming Welt Member to Flange

In mounting the seaming welt member 1 configured as described above on the flange 104, first, as illustrated in FIG. 5, the seaming welt member 1 is disposed such that the tip end portion of the flange 104 is disposed between the vehicle-interior side wall portion 10 and the vehicle-exterior side wall portion 20 of the seaming welt member 1. Thereafter, as illustrated in FIG. 6, the seaming welt member 1 is moved rearward and the flange 104 is inserted between the vehicle-interior side wall portion 10 and the vehicle-exterior side wall portion 20 of the seaming welt member 1. At this time, while a surface of the flange 104 on the vehicle-exterior side slidably contacts the inner surface of the outer wall portion 20 of the seaming welt member 1, the second holding lip 52 is pressed to the vehicle-interior side by the sealer 107. The second holding lip 52 pressed to the vehicle-interior side is deformed in a direction in which an angle between the inclined plate portion 52b and the tip end plate portion 52c is increased to be in an elongated shape, and therefore, the second holding lip 52 does not strongly interfere with the sealer 107, thus reducing an insertion force. Moreover, when the second holding lip 52 has an elongated shape, the tip end portion 52d of the second holding lip 52 engages in the recessed portion 55.

As illustrated in FIG. 7, when the flange 104 is completely inserted between the vehicle-interior side wall portion 10 and the vehicle-exterior side wall portion 20 of the seaming welt member 1, the tip end portion 51b of the first holding lip 51 abuts on the flange 104. When the tip end portion 51b of the first holding lip 51 abuts on the flange 104, the root portion 51a of the first holding lip 51 is connected to the inner surface of the vehicle-interior side wall portion 10 via the thin wall portion 53, and therefore, the first holding lip 51 can be easily displaced with a small force, so that the insertion force of the flange 104 is reduced.

When the flange 104 is completely inserted, a state where the seaming welt member 1 is mounted on the flange 104 is achieved. The tip end portion 52d of the second holding lip 52 engages in the recessed portion 55 between the root portion 51a of the first holding lip 51 and the inner surface of the vehicle-interior side wall portion 10 in the state described above, and therefore, the first holding lip 51 does not rotate in an opposite direction to the insertion direction of the flange 104. That is, the tip end portion 52d of the second holding lip 52 serves as a stopper that restricts rotation of the first holding lip 51. Thus, in a case where an external force in a direction in which the seaming welt member 1 is separated from the flange 104 acts on the seaming welt member 1 with the flange 104 inserted therein, when the tip end portion 51b of the first holding lip 51 is going to rotate rearward following movement of the flange 104, movement of the root portion 51a is restricted, and thus, the first holding lip 51 is tensioned between the flange 104 and the vehicle-interior side wall portion 10. With the first holding lip 51 tensioned therebetween, a retention force of the seaming welt member 1 is increased, and therefore, separation of the seaming welt member 1 from the flange 104 is suppressed.

In particular, for a seaming welt member with a sensor, it is necessary to securely mount the seaming welt member on the flange 104 such that the seaming welt member after being mounted is not displaced. By applying the present disclosure to the seaming welt member with a sensor, an attitude of the seaming welt member 1 mounted on the flange 104 can be kept in an attitude as designed and deterioration of a detection range of the sensor can be prevented.

Moreover, when the present disclosure is applied to a seaming welt member with a sealing portion that abuts on the vehicle body or another door to prevent intrusion of water, sound, wind, or the like into the vehicle interior, an attitude of the sealing portion mounted on the flange 104 can be kept, and therefore, a high sealing performance can be maintained.

The above-described embodiment is merely illustrative in all respects and should not be interpreted restrictively. Furthermore, all modifications and changes within an equivalent scope of the claims fall within the scope of the present invention. Note that, in the above-described embodiment, a case where the seaming welt member 1 is assembled to a structure where the sealer 107 is provided on the flange 104 has been described, but the sealer 107 may not be provided on the flange 104. The flange 104 may not be formed of metal. Although not illustrated, for example, when the flange is formed of resin, a hemming portion is not provided in some cases, and even when the seaming welt member 1 is assembled to the flange of the structure described above, the present disclosure is also applicable.

### INDUSTRIAL APPLICABILITY

As described above, a mounting structure of a seaming welt member according to the present disclosure can be used, for example, in mounting a sensor, an opening seal, a bonnet seal, a trunk seal, a parting seal, or the like on a flange of a door or a vehicle body.

### DESCRIPTION OF REFERENCE CHARACTERS

1 Seaming welt member
10 Vehicle-interior side wall portion (first side wall portion)
20 Vehicle-exterior side wall portion (second side wall portion)
30 Connecting wall portion
51 First holding lip
51a Root portion
52 Second holding lip
53 Thin wall portion
55 Recessed portion
104 Flange
107 Sealer

What is claimed is:

1. A mounting structure of a seaming welt member used for mounting the seaming welt member to a flange of an automobile, wherein
the seaming welt member includes a first side wall portion disposed on one side in a thickness direction of the flange, a second side wall portion disposed on the other side in the thickness direction of the flange, a connecting wall portion that extends in the thickness direction of the flange and connects the first side wall portion and the second side wall portion, and a first holding lip and a second holding lip that are provided on an inner surface of the first side wall portion,
the first holding lip is configured such that a root portion thereof is connected to the inner side of the first side wall portion via a thin wall portion and is in an inclined attitude in which the first holding lip gets closer to the second side wall portion as proceeding to a deep side in an insertion direction of the flange, and
the second holding lip is positioned further on a near side in the insertion direction of the flange than the first holding lip, is configured to have a bent shape located separated from the root portion of the first holding lip to the near side in the insertion direction of the flange when the flange is not inserted and, on the other hand, during insertion of the flange, be deformed from the bent shape into an elongated shape due to a pressing force by the flange, and is configured such that, when insertion of the flange is completed, a tip end portion thereof engages between the root portion of the first holding lip and the inner surface of the first side wall portion.

2. The mounting structure of a seaming welt member according to claim 1, wherein
a recessed portion that is opened to the near side in the insertion direction of the flange is formed between the root portion of the first holding lip and the inner surface of the first side wall portion, and
when insertion of the flange is completed, the tip end portion of the second holding lip engages in the recessed portion.

3. The mounting structure of a seaming welt member according to claim 1, wherein
the second holding lip includes an inclined plate portion that is inclined to be positioned further on the deep side in the insertion direction of the flange as proceeding from the inner surface of the first side wall portion to the tip end side and a tip end plate portion that extends from a tip end portion of the inclined plate portion to the deep side in the insertion direction of the flange, and
the inclined plate portion and the tip end plate portion together form the bent shape.

4. The mounting structure of a seaming welt member according to claim 1, wherein
the flange includes a sealer applied on the one side in the thickness direction, and
the second holding lip is pressed by the sealer during insertion of the flange.

5. The mounting structure of a seaming welt member according to claim 4, wherein
the sealer is applied to a portion of the flange separated from the tip end portion of the flange in the insertion direction toward a base end thereof, and
the tip end portion of the first holding lip abuts on a portion of the flange located further on the tip end side in the insertion direction than the sealer when insertion is completed.

6. The mounting structure of a seaming welt member according to claim 4, wherein
a portion between a root portion and the tip end portion of the second holding lip is formed to be separated from the inner surface of the first side wall portion when insertion of the flange is completed.

7. A sensor to which the mounting structure of a seaming welt member according to claim 1 is applied.

8. A weather strip to which the mounting structure of a seaming welt member according to claim 1 is applied.
